(19) United States
(12) Patent Application Publication
(10) Pub. No.: US 2002/0152258 A1
(43) Pub. Date: Oct. 17, 2002

(54) Method and system of intelligent information processing in a network

(76) Inventor: Hongyi Zhou, Beijing (CN)

Correspondence Address: LADAS & PARRY, 224 SOUTH MICHIGAN AVENUE, SUITE 1200, CHICAGO, IL, 60604, US

(21) Appl. No.: 10/069,415

(22) PCT Filed: Jun. 28, 2001
(86) PCT No.: PCT/CN01/01062

(51) Int. Cl. G06F 15/16

(52) U.S. Cl. 709/201

(57) ABSTRACT

A method and system of intelligent information processing in the Internet comprises identifying whether an input is one of a URL address, English words, native language characters, and native language pronunciation notations. If the input is a regular URL, the system queries the input in a corresponding server through the Internet, and directly obtains the query result therefrom. If the input includes the native language pronunciation notations, the system parses the input against at least one phonetic spelling word list to find out corresponding Internet keyword, and then fetches a corresponding query result; and if the input includes characters of a native language, the system processes the input as a natural language input in a natural language table, and obtaining a desired Internet keyword, and fetches a corresponding query result of website URL.

### FIELD OF INVENTION

The present invention relates to a method and system of intelligent information processing in a wide area network, such as Internet, through native language, such as Chinese. More particularly, it relates to a method and system of Chinese intelligent search in the Internet.

### BACKGROUND OF THE INVENTION

A Network is a distributed communicating system of computers that are interconnected by various electronic communication links and computer software protocols. A WAN (wide area network) is a geographically dispersed telecommunications network and the term distinguishes a broader telecommunication structure from a local area network (LAN). A wide area network may be privately owned or rented, but the term usually connotes the inclusion of public (shared user) networks. A particularly well-known WAN is the international information infrastructure, commonly called the Internet. The Internet is a worldwide network whose Electronic Resources include (but are not limited to) text files, graphic files in various formats, World Wide Web “pages” in HTML (Hyper Text Mark-Up Language) format or various extensions, including XML, files in various and arbitrary binary formats, and electronic mail addresses. As in many other networks, the scheme for denotation of an Electronic Resource on the Internet is an “electronic address” which uniquely identifies its location within the network and within the computer in which it resides.

On the Internet, for example, such an electronic address is called a Universal Resource Locator or URL, and consists of a specially formatted concatenation of information about the type of protocol needed to access the resource, a Network Domain identifier, identification of the particular computer on which the Electronic Resource is located, a port number, directory path information within the computer's file structure, and the file name of the resource. Internet URLs and similar denotation schemes for Electronic Resources are cumbersome for human users. URLs are often more than 50 characters long and contain information that is neither interesting nor meaningful to seekers of information. Thus, some works have been done to make the search of web addresses under URL more meaningful to the information seekers or searchers. That is the seekers or searchers do not have to remember the exact URLs in the search engines, but some naturally used words or terms.

U.S. Pat. No. 5,764,906 describes a system for providing and maintaining short aliases for information resources and their providers and a system for translation of these aliases to meaningful electronic addresses, such as URL's, facsimile and voice telephone numbers and electronic mail addresses, and for accessing the resources by means of these addresses. Similarly, PCT application WO 99/39275, published on Aug. 5, 1999 describes a method of navigating the Internet to a resource based upon a natural language name, to a resource that is stored in a network and identified by a location identifier. Certain software products have become commercially available to assist the access of Internet resources using natural language names.

At present, many of such services are available. For instance, RealNames (Central Co. http://www.realnames.com) substitutes short “keywords” for complicated Internet addresses, or URLs, and has already offered its service through Microsoft's Internet Explorer Web browser and MSN Web portal. Microsoft also announced the inclusion of RealNames in its Web browser software. RealNames' service is an Internet equivalent to America Online's popular keyword system, part of its proprietary online service. The system allows AOL members to. type a common phrase to find specific content channels. Similarly, Netword Agent software (http://www.netword.com) also allows a user to enter Internet keyword instead of a URL. In addition, Internet Engineering Task Force (IETF) is developing an Internet keywords standard. The IETF already has formed a working group devoted to devising a “common name resolution protocol,” or a standard way of implementing Web keywords.

However, the Internet keyword software products, such as those from RealNames or Netword, are either incorporated to a browser or as a plug-in for the browser. Generally, when a new version of the browser is released, the plug-in software must also be updated.

Furthermore, the Internet keyword software products or keyword searches are either not suitable or cumbersome for processing certain native language, such as Asian languages, particularly Chinese, Japanese and Korean, or any other pictographic languages. Each character may not have an exact meaning, and may have various meanings when being combined with one or more other characters. Therefore, normal keyword search techniques cannot be used to obtain quickly and accurately desired search results of such electronic addresses.

It is then an object of the present invention to provide a method of processing search inquiries in native languages, such as Chinese.

It is another object of the present invention to provide a system of information processing in the Internet using native languages, such as Chinese.

It is a further object of the present invention to provide a method and system of Chinese intelligent search in the Internet, either based on the characters or based on “pinyin” that is the pronunciation of the characters.

It is still a further object of the present invention to provide a method and system of Chinese intelligent search in the Internet, automatically obtaining correct results even if the pinyin is entered with southern accent.

### SUMMARY OF THE INVENTION

In accordance with the present invention, a method and system of intelligent search in the Internet comprises identifying whether the input is one of a URL address, native language characters, and native language pronunciation notations. If the input is a regular URL, the text input is queried in a domain name server and the query result is sent back to the browser. If the input includes characters of a native language, the input is processed as a natural language input. The search inquiry will be sent to the search engine, either remote or local, that performs an intelligent search based on the native language characters. The search result will be sent back to the browser, indicating the desired URL or web-address.

If the input is determined as the native language pronunciation notations, i.e., phonetic spellings, it will be further determined whether the input is a full pronunciation notation (phonetic spelling) or abbreviations of first letters of the pronunciation notation. If the input is a full pronunciation notation query, the query will be processed in the pronunciation notation search table to obtain the desired URL or web-address, and the result will be sent back to the browser for selection. Otherwise the input will be processed in the search table of abbreviations of first letters of pronunciation notations of the native language. The query result of the URL or web-address will be sent to the browser for selection.

In accordance with the present invention, the intelligent search will comprise the determination whether a query matches precisely a website or webaddress or webpage. If it does not have a precisely matching website or webpage, a list of possible search results is provided to the user for selection.

Chinese character input is difficult for many users. However, if the computer of the browser is equipped with the Chinese input software, the Chinese characters may be entered as a search inquiry. This will initiate the intelligent search of Chinese characters. To provide users with more options, in certain embodiments of the present invention, the system and method of intelligent information processing may accept “Pinyin” i.e., pronunciation notations or “Pinyin” headers, i.e., pronunciation alphabet abbreviations of desired query term so as to get a list of possible search results.

The system and method may also process telephone number input and get to a relevant website corresponding to the registered telephone number. If a person's name (either in Chinese or English) is entered, the person's web-card may be retrieved from a remote webcard server, such as the one provided by http://www.letscard.com, or any other similar servers. These aspects of the invention are closed in other corresponding patent applications of the same applicant.

### BRIEF DESCRIPTION OF THE DRAWINGS

The accompanying drawings illustrate the embodiments of the present invention and the present invention can be better understood through them following detailed description in connection with the accompanying drawings.

FIG. 1 illustrates an example of a networked computer system that may be utilized to execute the software of an embodiment of the invention.

FIG. 2 shows one embodiment of the invention.

FIG. 3 shows a process of controlling a browser's URL input window.

FIG. 4 shows a screen shot of a browser with Chinese Natural Language Access and Navigation Service.

FIGS. 5A, 5B, and 5C illustrate the three basic infrastructures of the intelligent information processing in a wide area network in accordance with the present invention.

FIG. 6 shows a process for Chinese natural language processing.

FIG. 7 shows another process for Chinese natural language processing.

FIG. 8 shows the method of Chinese characters and/or English words processing of the present invention.

FIG. 9 shows the method of full Chinese phonetic spelling words processing of the present invention.

FIG. 10 shows the method of abbreviated Chinese phonetic spelling words processing of the present invention.

FIG. 11 illustrates the process of determining types of words of a query entry before the information processing in accordance with the present invention.

FIGS. 12A and 12B illustrate, respectively, the search method of homonym words of full phonetic spelling and the search method of full phonetic spelling words with dialect misspellings in accordance with the present invention.

### DETAILED DESCRIPTION OF THE PREFERRED EMBODIMENTS

As will be appreciated by anyone skilled in the art, the present invention may be embodied as a method, data processing system or program products. Software written according to the present invention is to be stored in some form of computer readable medium, such as memory, or CD ROM, or transmitted over a network, and executed by a processor. Nonetheless, the principles of the present invention may be described in a method of intelligent information processing in a network or a system of intelligent information processing in a network as stated in details hereinafter.

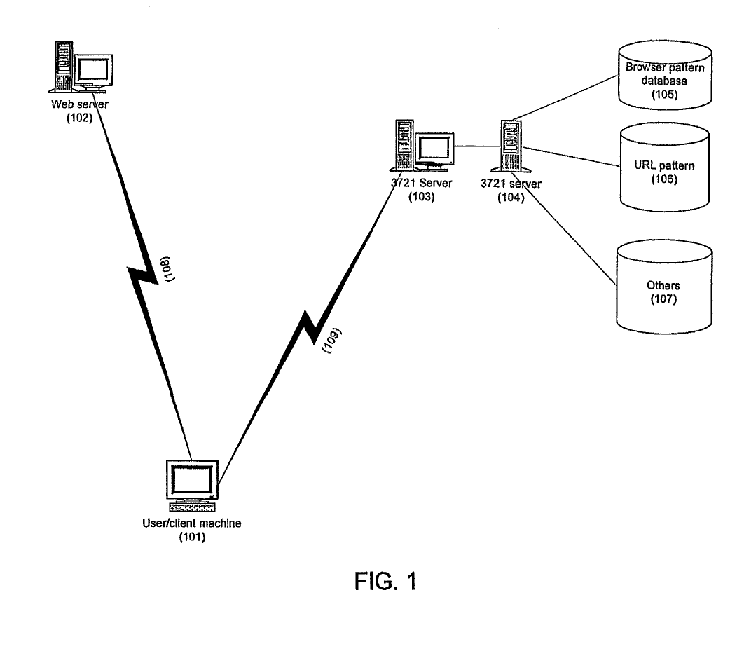

FIG. 1 shows a system of the present invention. A user machine/computer 101 is connected to web servers 102 and Internet resource locater servers such as the servers 103 and 104 at http://www.3721.com via Internet connections 108, 109. The user computer 101 may be any kinds of computers running Microsoft® Windows operating system, including PCs, Macintosh computers, an Internet appliance such as a WebTV and a wireless Internet browsing device. The user computer 101 may be connected to the Internet via a dial in modem, a DSL line, a cable modem, a dedicated line such as T1 or T3, or an optical fiber connection. A person skilled in the art would appreciate that this invention is not limited to specific type of user computer or connection between the user computer and the Internet. The Internet resource locater servers 103 and 104 include the browser pattern database 105, URL pattern 106, and other patterns 107.

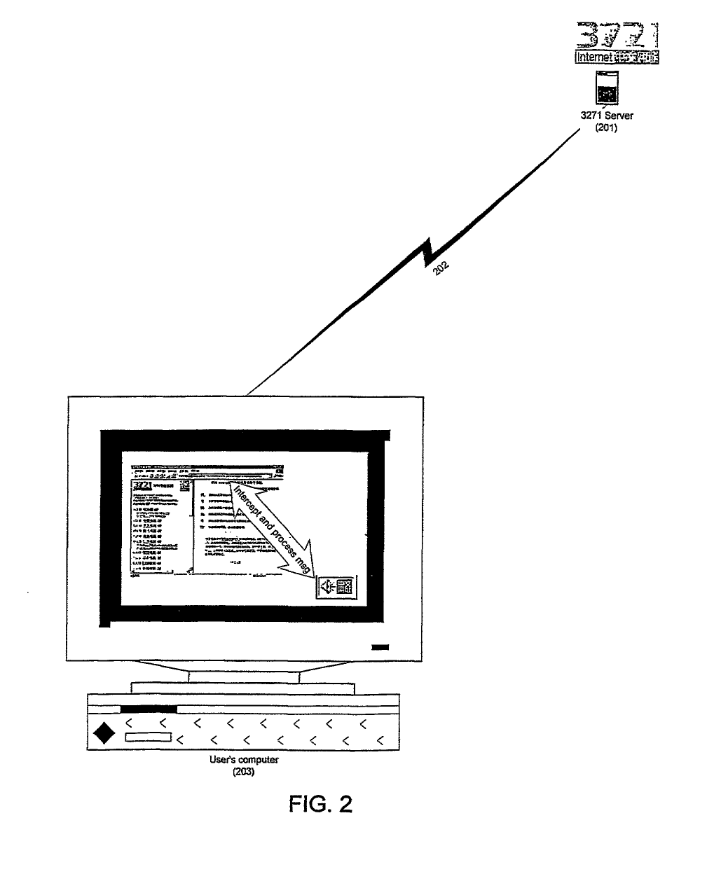

FIG. 2 shows a user computer 203 connected, via Internet connection 202, to an Internet resource locator server 201, such as 3721 server or other servers containing the server software of the present invention. An image of the screen of a browser is executing in the user's computer 203. Small user-end computer software of the invention is also executing in the user's computer 203 (see the small picture on the bottom of the screen). The small user-end computer software intercepts the text message (msg) input from the address box of the browser. The message is either transmitted to the Internet resource locator server 201 for processing or processed locally by the small user-end software.

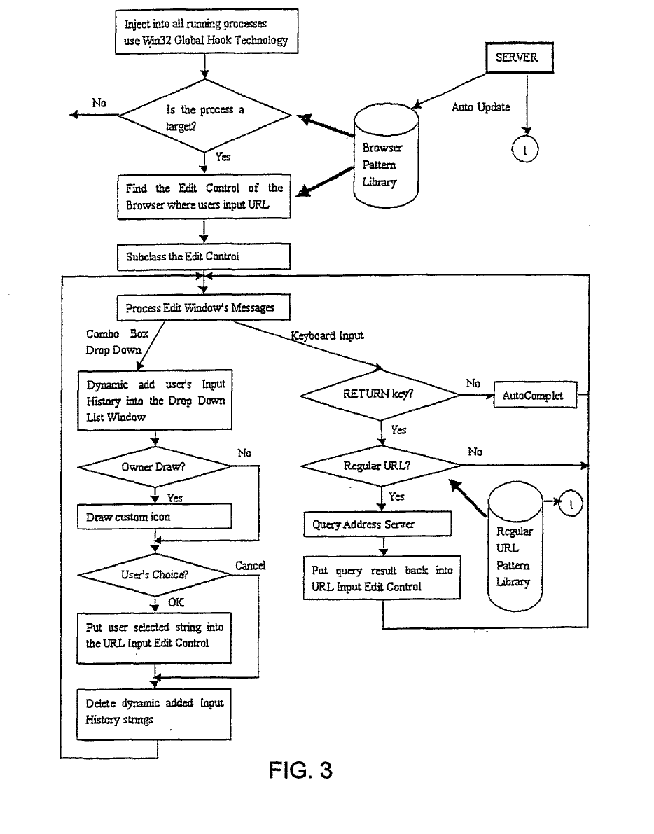

FIG. 3 shows the process performed by the user end software of the present invention. The user end software inject into all running processes use win 32 hook technology. A hook is a point in the Microsoft® Windows message-handling mechanisms where an application can install a subroutine or a separate module to monitor the message traffic in the system and process certain types of messages. A hook procedure can be global, monitoring messages for all threads in the system, or it can be thread specific, monitoring messages for an individual thread. Some hooks may be set with system scope only (e.g. WH_SYSMSGFILTER), but most hooks have either system or thread scope. Teachings on the user of Win32 hooks may be found, for example, at Microsoft® MSND web site (http://www.microsoft.com).

All running processes are checked to determine whether it is a target. If it is a target, information about the process is used to find the edit control of the browser where users input URL. The information may be user to search a browser pattern library to determine which version of the browser is executing in the user's computer. The database may be automatically updated.

Once the edit control is found, a subclass is created. The message of the Edit Window may be combo box, drop down selection or keyboard input. If it is a keyboard input, it is checked to see whether it is a URL address. It is also search against a database with regular URL pattern library. If it is combo box or drop-down selection, it is processed as shown in FIG. 3.

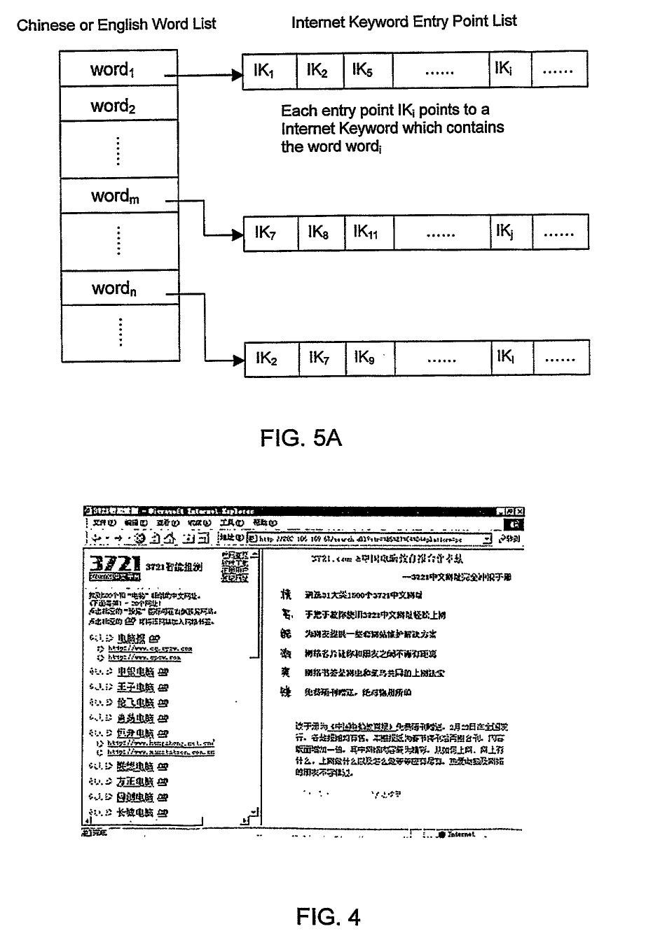

FIG. 4 shows an image of a browser (in Chinese version) interacting with the user end software of the present invention. A user enters the word “computer” in Chinese in the address box of the browser, a list of addresses in Chinese related to this word is generated.

Nonetheless, nowadays, the web search of desired websites is not only carried out through English words, using either URL or keywords, but also carried out in other native languages, such as Chinese. This will require some pertinent information processing method or system that may effectively and accurately carry out such web search using the native languages.

It can be appreciated that a search is normally carried out through a database that contains particularly designed search tables to facilitate various search tasks. There is no exemption for web search in, for instance, Chinese languages. For purpose of carrying out the search of the present invention, at least the Internet resource locator server should contain at least a Chinese character search index table, a full phonetic spelling (Pinyin) search index table, and phonetic spelling alphabet abbreviation (Pinyin header) of Chinese words search table.

Normally, when a query of keywords is entered, the entered phrases of the keywords are broken down into several meaningful words that will be matched against the search table of predetermined structure. Then, the results of the words will be considered together to determine the final result or results of the query. However, for some native languages, such as Chinese, the entered query may be in Chinese characters. Each character may or may not have any exact meaning, and a combination of one character with other characters may create various meaningful Chinese words. Hence, a simple breakdown of a query in Chinese may not assure an accurate result of the query. Thus, the present invention separates the entered phrase or characters of the query into meaningful Chinese words of all possible combinations of the entered Chinese characters.

For instance, the first character is not just simply combined with the following second and/or third characters to get the meaningful word, and then the subsequent characters, after the previous combination, will form any other meaningful words. In the present invention, the first character will be combined with anyone of the entered characters to form all possible meaningful words for the query. Therefore, the obtained query results may assure the accuracy of the query when all results come from all of these possible combined meaningful words.

The possible query. inputs in Chinese based websites are Chinese character inputs, URL inputs, and Pinyin inputs that further include full phonetic spelling inputs, first letter abbreviations of phonetic spelling, homonym of phonetic spelling inputs, and local accent phonetic spelling inputs. Before going into the details of the method and system of the present invention for each of the aforesaid inputs, a discussion of the current techniques of Chinese inputting may assist the better understanding of the present invention.

The major encoding systems for Chinese are: Big 5, and Guobiao (i.e., national standard). Generally, Big5 is preferred for processing traditional Chinese characters or Guobiao for the simplified characters. Under the Big 5 encoding system popular in Hong Kong and Taiwan, the coding for (tian, “sky”) is 1101000110100100. The Guobiao encoding for “tian” is 1110110011001100. Note that the Big 5 code or Guobiao code for “tian” above begins with a 1, while the ASCII code for letter “A” begins with a 0. This pattern holds generally true, that is, all Chinese codes begin with 1 and all ASCII codes begin with 0. In this manner, in a file that contains both English and Chinese text, the system can detect whether a given byte is intended as English or Chinese.

Entering (inputting) and processing Chinese language text on a computer is a very difficult problem. The shear numbers of Chinese characters illustrate this difficulty. In the square-character (Hanzi) writing system of Chinese, there are 3000 to 6000 commonly used Chinese characters (Hanzi). Including the relatively rare ones, there are more than ten thousands Chinese characters. Adding to this difficulty, there are problems in the Chinese language with text standardization, multiple homonyms, and ill-defined word boundaries that impede effective text processing of Hanzi with computers. In spite of intensive studies for several decades and the existence of hundreds of different methods, computer input and processing of Chinese is a major stumbling block preventing the use computers in China, particularly for text processing.

At present, computer systems available for inputting and processing Chinese language text may be divided into three categories. The first category is based on a decomposition of the Chinese characters into elementary graphical components. The decomposition of Chinese characters of each method is not unique. Therefore, it is rather difficult for people to learn those methods.

The second and third categories are based on pronunciation, such as full phonetic spelling method. These methods encounter a “homonym problem” in Chinese language processing. The second category is phonetic input, (e.g. “Pinyin” for mainland China and “phonetic symbols” or BPMF for Taiwan) which is the most commonly used method for everyone except professional typists. The Chinese character writing system of Chinese language is a conceptual and practical barrier to this method.

Although there are only about 1300 different phonetic syllables, in contrast to tens of thousands of characters, one phonetic syllable may correspond to many different Chinese characters. For example, the pronunciation of “yi” in Mandarin can correspond to over 100 Chinese characters. This creates ambiguities when translating the phonetic syllables, as the inputs, into the corresponding Chinese characters.

To address this “homonym problem,” most of the phonetic input systems use a multiple-choice method. See for example, German patent 3,142,138, issued May 5, 1983 to J. Heinzi et al.; U.S. Pat. No. 5,047,932, issued Sep. 10, 1991 to K C. Hsieh; and Chinese Patent Publication No. 1064957, issued Mar. 8, 1991 to Tan Shanguang. After a phonetic syllable is keyed in, the computer displays all possible characters with the same pronunciation. In some cases, there is not enough space on the screen to display all possible characters with the same pronunciation. This will require scrolling up and down. Therefore, these phonetic methods, based on individual syllables, are very slow.

An improvement to the multiple-choice methods based on deriving probability of the adjacent Chinese characters is disclosed in, for example, British Patent 2,248,328, issued on Apr. 1, 1992 to R. W. Sproat. The probability approach can further be combined with grammatical constraints. See for example, K. T. Lua et al., Computer Processing of Chinese and Oriental Languages, Vol. 6, Num 1, page 85, June 1992. However, the conversion accuracy (phonetic to characters) of these methods is typically limited to around 80%.

The third category combines a phonetic-character input method with the addition of non-phonetic letters. Non-phonetic letters are added to the phonetic letters to artificially discriminate characters with the same pronunciation. Examples include phonetic spelling with radical marks (British Patent No. 2,158,776, issued Nov. 20, 1985 to C. C. Chen) and phonetic spelling with number of strokes (Chinese Patent Publication No. 1066518, issued Nov. 25, 1992 to G. Xie). These methods require memorizing artificial rules or counting number of strokes that slows down the speed of input substantially.

Other methods for inputting Chinese characters are described in, for example, U.S. Pat. No. 6,073,146. The '146 patent teaches a system employing a keyboard with diacritic keys (and corresponding ASCII coding) that permit the user to annotate each entered phonetic text syllable with a diacritic that indicates the tone of the syllable. A process executing on the system determines that a syllable has been entered when a diacritic (or delimiter) key is struck. All entered phonetic syllable is then compared to a list of acceptable phonetic syllables and abbreviations. If the entered syllable is on the list, the correctly spelled and accented syllable is stored in memory and displayed on a phonetic portion of a graphical display. The process continues for succeeding syllables until a delimiter is entered. Upon encountering a delimiter, the word string (defined as the string of characters between two delimiters) is analyzed using morphological and syntactical processes and/or a statistical language model to unambiguously determine the proper Chinese characters that represent the word(s) in the word string. The unique Chinese translation is stored in memory and displayed on a Chinese character portion of the graphical interface.

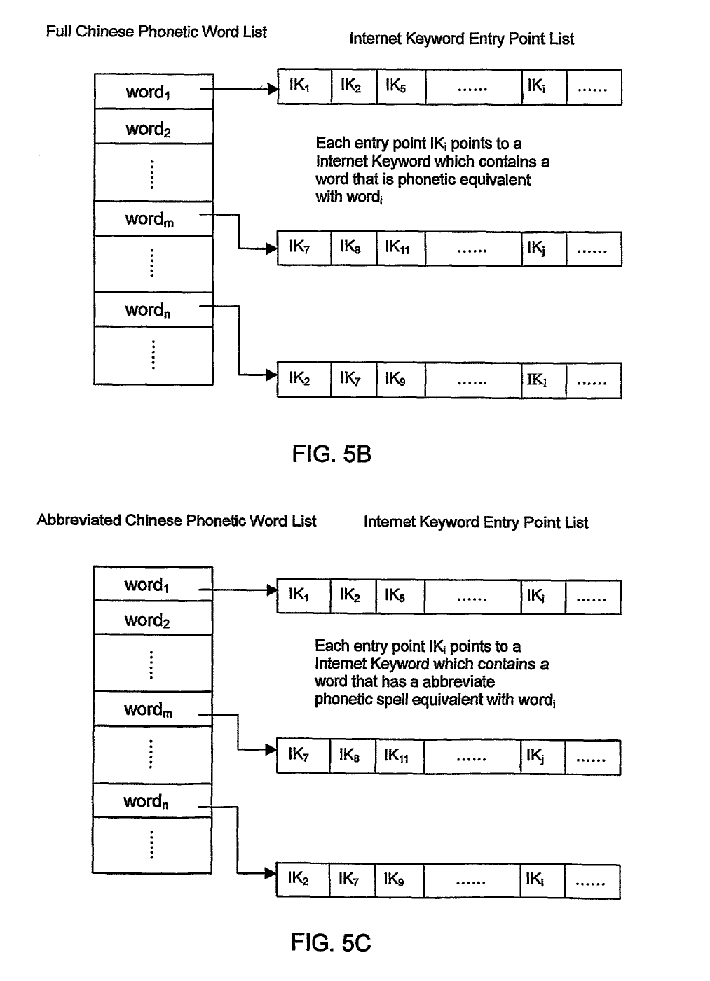

In accordance with the present invention, the query index data structure for Internet keyword search are illustrated in FIGS. 5A, 5B, and 5C. These are the approximate infrastructure of three search index tables of the present invention. In order to realize the high speed intelligent search of Internet keyword, it is very important to establish a high efficient data infrastructure that is suitable for searching massive data. The three data structures of the present invention are (1) the index table for intelligent search for identifying words or phrases of normal Chinese characters and English word; (2) the index table for intelligent search based on full phonetic spelling of Chinese characters; (3) the index table for intelligent search based on phonetic spelling alphabetic abbreviation.

With respect to FIG. 5A, the index table is a Chinese or English Word List that contains all Chinese or English words, for instance, “China”, “software”, “computer”, “ibm” etc. In the Chinese or English Word List, each word is connected to an internet Keyword Point List In such a table, each point indicates a pointer pointing toward an actual storage space of an Internet Keyword, in which such a word is contained. Therefore, it may search for all Internet keywords that contain the word, either in Chinese or English, from the Internet Keyword Entry Point List linked to each of said words.

With respect to FIG. 5B, the data structure is similar to the one in FIG. 5A. Only the left side Chinese words are in the form of Pinyin, i.e., phonetic spellings. For instance, the above given words in Chinese are now “zhongguo”, “ruanjian”, “diannao”, etc. The linked Internet Keyword Entry Point List is a list of the Internet Keywords that contain such a word in Chinese phonetic spelling form.

FIG. 5C also has similar data structure as the one in FIG. 5A. The difference is that on the left side of the word table each of such words is in the form of phonetic spelling alphabetic abbreviations, such as, “zg”, “rj”, “dn” etc. Thus, the related Internet Keyword Entry Point List includes words corresponding to these phonetic spelling alphabetic abbreviations for the query. From these three figures, it can be seen that the three basic intelligent search methods have similar data structure, but have the words stored in different forms of Chinese or English words, full phonetic spelling (Pinyin), or phonetic spelling alphabetic abbreviations (headers of phonetic spelling words). Therefore, it can be understood that the internal computing method for these three kinds of search is the same. The key is how these words being grouped or selected from the query to form meaningful search words. As discussed above, the query is broken up into several combinations of characters indicative of all possible meaningful words as thus combined to assure every possible search words pointing to the Internet Keywords on the list, and how the query is identified as Chinese character entry or English word entry, full phonetic spelling word entry or phonetic spelling alphabetic abbreviation entry. The corresponding methods according to the present invention are discussed hereinafter.

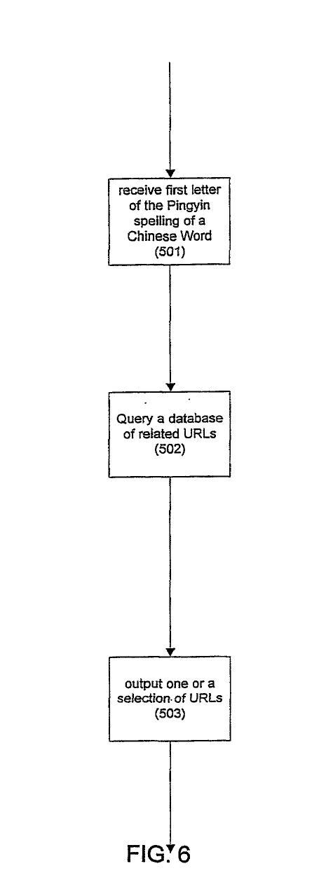

Despite of the development of easier methods, inputting Chinese characters is still an extremely difficult task. Particularly if the internet device is a handheld device such as a Personal Data Assistant or a cell phone with wireless internet connection. In one aspect of the invention, methods for simplifying the entry of Chinese characters are provided. The methods are particularly useful for entering web addresses or natural language keywords or names of a web site (page). FIG. 6 shows one embodiment of the invention. In this method, the user types in the first letter of the Pinyin spelling of a Chinese word indicated at 501. The first letter is used to query a database and a list of possible URLs are listed indicated at 502. The list may be based upon statistical information such as frequency of requests. In other words, the most popular URLs are listed first indicated at 503.

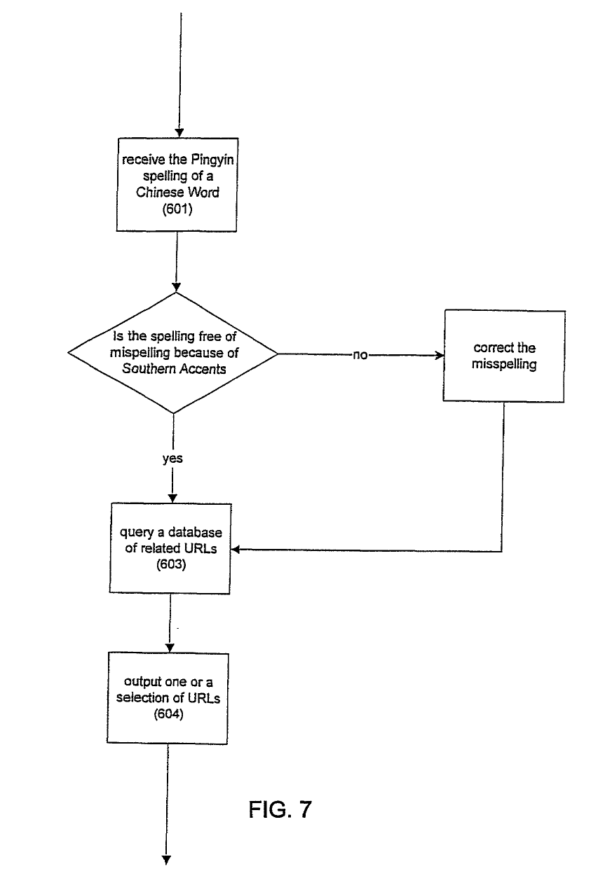

In another embodiment of the invention as seen in FIG. 7, the Pinyin spelling of a Chinese word is inputted at 601. The spelling is checked to determine whether it contains frequent misspellings at 602. Misspelling frequently occurs because of accent. In the southern part of China, because of southern accent, many southerners make phonetic spelling mistakes of Chinese characters. If the phonetic misspelling occurs due to the southern accent, the system of the present invention will correct them automatically at 605. If the query does not have any phonetic misspelling or the misspelling has been correct, it will then check a database of related URLs at 603. The output will be displayed at 604.

The small user-end software that is supported through a back-end intelligent search engine and database exemplifies one embodiment of the invention. The software may be downloaded from http://www.3721.com. Users do not need to know or type the long and complicated alphabetical URLs, instead they simply type Chinese characters, in the web address box, for familiar brands, product names, and they will be brought to their desired destination sites or related webpages. For example, instead of typing http://www.legend.com.cn, users can simply type “Legend Computers” in Chinese and will get to the site they wish to visit.

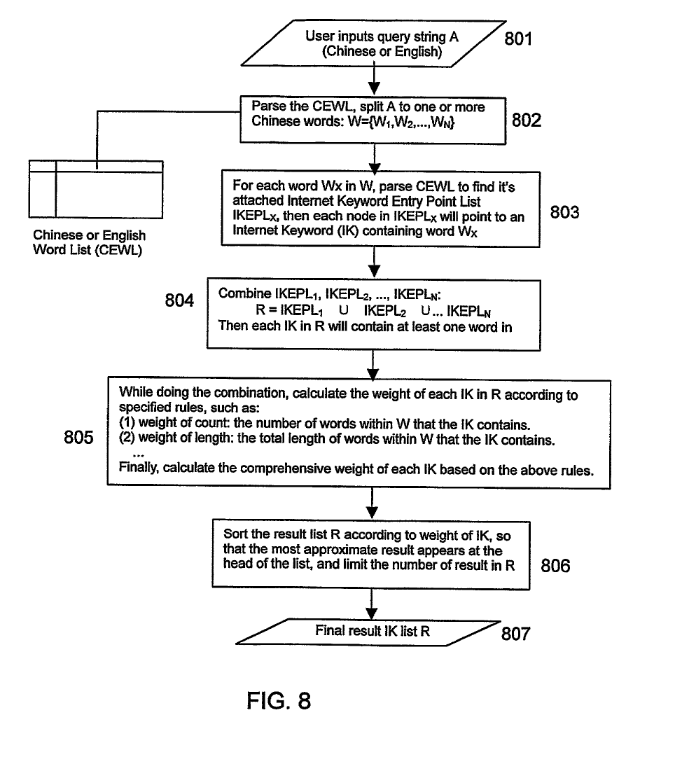

Turning now to the key features of the present invention, FIG. 8 shows the basic flow chart of the Chinese character and/or English words search of the present invention. After the query string A in the form of Chinese characters and/or English words is entered at 801, the system will parse the query string A against the Chinese English Words List (CEWL), and split the query string A to one or more Chinese words: W={W₁, W₂, . . . , W_{N}} at 802. For each word Wx in W, at 803 the system parses the word Wₓ in the CEWL to find the attached Internet Keyword Entry Point List (IKEPLₓ), and then each node in the IKEPLₓ will point to an Internet Keyword (IK) containing the word Wₓ.

The system will combine all IKEPL₁, IKEPL₂. . . IKEPL_{N} and get the result R at 804, that is, R=IKEPL₁∪IKEPL₂∪ . . . IKEPL_{N}. Since each IKEPLₓ points to an IK containing a word Wₓ, an IK in R will then contain at least one word Wₓ in W. At 805, while doing the combination, the system will calculate the weight of each IK in R according to specified rules, such as the followings:

(1) Weight of count: the number of words within W that the IK contains.

(2) Weight of length: the total length of words within W that the IK contains . . . Finally, the system will calculate the comprehensive weight of each IK based on the above rules. After the calculation, at 806 the system will sort the result list R according to weight of IK, such that the most approximate result appears at head of the list, and the system will limit the number of result in R. Then, the final IK list R appears at 807.

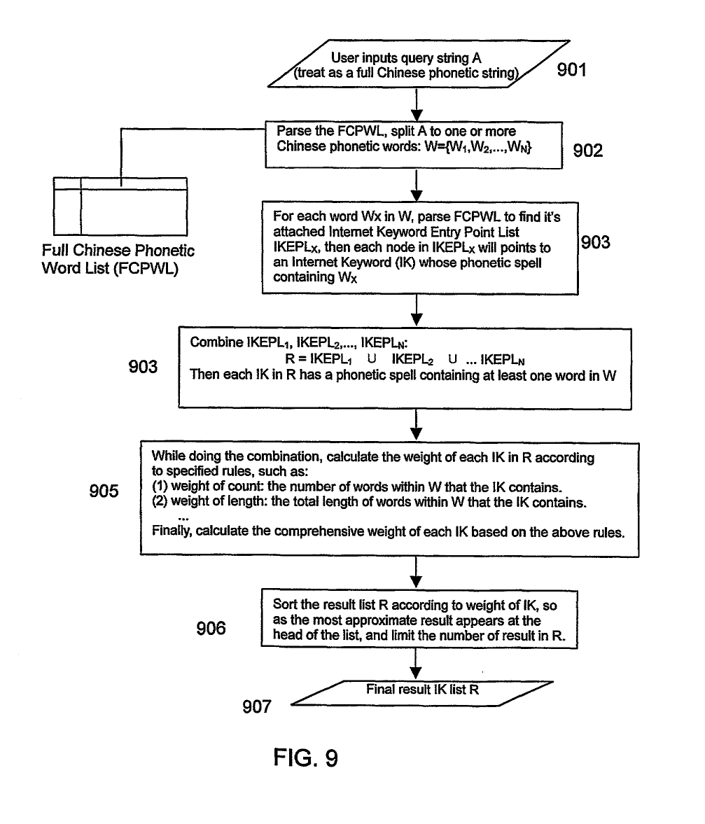

Likewise, as seen in FIG. 9, the entered query string A is in the form of full phonetic spelling at 901. After the entry of the string A, the system parses the string A against Full Chinese Pinyin Words List (FCPWL) and splits it into one or more Chinese phonetic spelling words: W={W₁, W₂ . . . W_{N}} at 902. For each word Wx in W, at 903 the system will parse it in the FCPWL to find the attached Internet Keyword Entry Point List IKEPLₓ, and then each node in

IKEPLₓ will point to an Internet Keyword (IK) whose phonetic spelling containing Wbₓ. Then, at 904, the system combines IKEPL₁, IKEPL₂, . . . , IKEPL_{N} to obtain a result R=IKEPL₁∪IKEPL₂∪ . . . IKEPL_{N}. Thus, each IK in R has a phonetic spelling containing at least one word Wₓ in W. The following steps 906-907 are very much the same as those of 805-807, that is, calculating the weight of each IK in R according to specified rules; sorting the result list R according to weight of IK, so as the most approximate result appears at head of the list, and limit the number of result in R; and the finally obtaining a result IK list R.

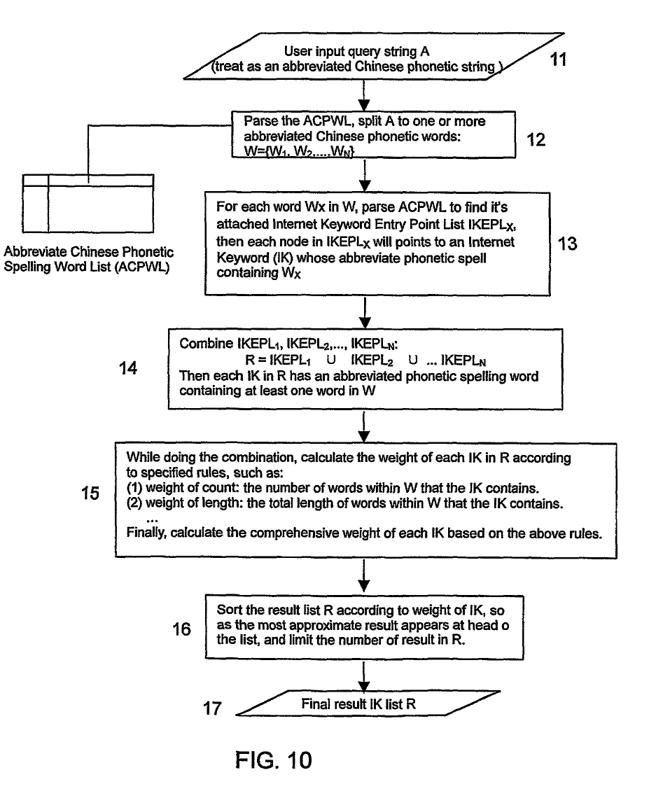

For the same token, as seen in FIG. 10, a user will input a query string A in an abbreviated Chinese phonetic spelling string A at 11. The system parses the string A against ACPWL, and splits the string A into one or more abbreviated Chinese phonetic spelling words: W={W₁, W₂, . . . , W_{N}} at 12. Then at 13, for each word Wx in W, the system parses the word in ACPWL to find the attached Internet Keyword Entry Point List IKEPLₓ, and then each node in IKEPLₓ will point to an Internet Keyword (IK) whose abbreviate phonetic spelling containing the word Wₓ. Then at 14, the system combines IKEPL₁, IKEPL₂, . . . , IKEPL_{N} to get a result R=IKEPL₁∪IKEPL₂ . . . IKEPL_{N} and then each IK in R has an abbreviated phonetic spelling containing at least one word Wₓ in W. The following steps 16-17 are substantially the same as those in FIGS. 8 and 9, that is, calculating the weight of each IK in R according to specified rules; sorting the result list R according to weight of IK, such that the most approximate result appears at head of the list, and limiting the number of result in R, and obtaining the final result IK list R.

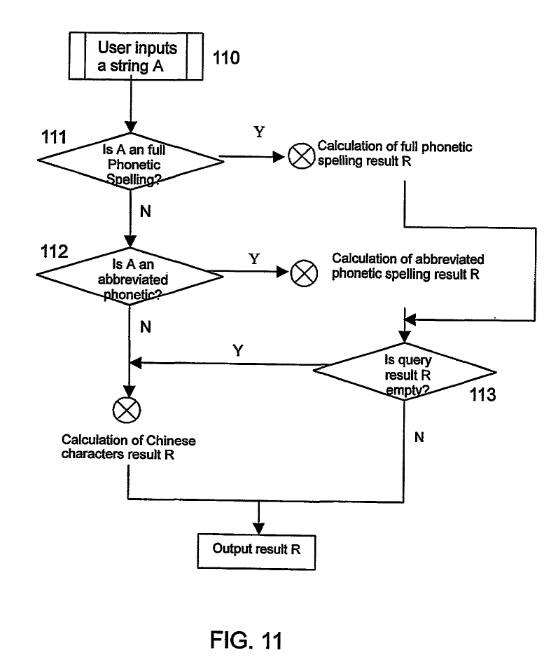

On the basis of the above three kinds of intelligent search modes, i.e., for Chinese characters and/or English words, full Chinese phonetic spelling words, and abbreviated Chinese phonetic spelling words, the method and system of intelligent information processing in a wide area network, according to the present invention, will determine whether the query entry is a string of Chinese characters and/or English words, full Chinese phonetic spelling words, and abbreviated Chinese phonetic spelling words as shown in FIG. 11. That is, after the entry of a string A at 110, the system will determine whether the entered query string is in the form of full Chinese phonetic spelling words at 111. If it is, the system will carry out the calculation in accordance with the intelligent search method of full phonetic spelling words search as shown in FIG. 9.

If it is not a string of full Chinese phonetic spelling words, the system will determine whether the query string is in the form of abbreviated Chinese phonetic spelling words at 112. If it is, the system will carry out the calculation of abbreviated Chinese phonetic spelling words as shown in FIG. 10. If it is not, the system thus determines that the query string is in the form of Chinese characters and/or English words, and will carry out the calculation of the same as shown in FIG. 8. However, in one situation, the system will determine whether the calculation result of either the full Chinese phonetic spelling word search or the abbreviated Chinese phonetic spelling words search is empty at 113. If it is empty, the system will do the calculation of Chinese characters and/or English words search as seen in FIG. 8 again. If the calculation of the search mode of FIG. 9 or FIG. 10 is not empty, the calculation result thereof will then be determined as the final result.

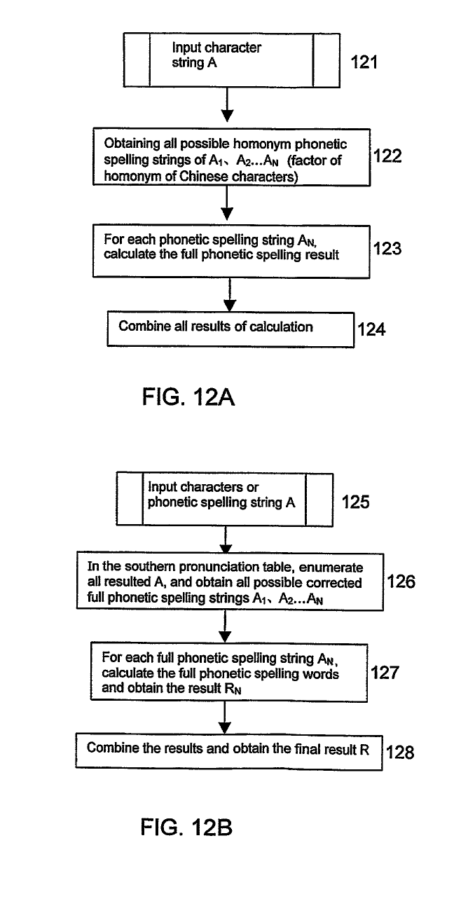

FIG. 12A illustrates a search method of homonym words of full phonetic spelling in accordance with the present invention. After the query string is entered at 121, the system will analyze all possibility of the homonym words, and generate all of these words as searchable words of full Chinese phonetic spelling at 122. For each of the homonym words of full Chinese phonetic spelling, the system will carry out, at 123, the calculation of full Chinese phonetic spelling words search as discussed with respect to FIG. 9. After obtaining all search results RN, the system will analyze the results RN and obtain the final and most possible result or limited number of results at 124.

FIG. 12B illustrates a search method of full phonetic spelling words with dialect misspellings in accordance with the present invention, Furthering the method and system of FIG. 7, after the entry of a query string of phonetic spelling words at 125, the system of the present invention will analyze, at 126, the entered words against a table listing all possible misspelled consonants or vows for corresponding Chinese characters by southerners, such as “huang” and “wang”, “shi” and “si”, “flu” and “lü”, etc. Anyway the possible misspelling words are enumerated on the list. Thus, the entered query string is separated into several words of phonetic spelling to cover all possible spelling words, and then they are calculated through the method of full phonetic spelling search to obtain all possible IK of the result at 127. Then, the search results are analyzed to obtain the final and most possible result or results at 128.

It can be understood that the above description is intended to be illustrative and not restrictive. Many variations of the invention will be apparent to those skilled in the art upon reviewing the above description. The scope of the invention should, therefore, be determined not only with reference to the above description, but also with variations and equivalent. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention.

1. A method of intelligent information processing in the Internet comprising:
a) identifying whether an input is one of a URL address, English words, native language characters, and native language pronunciation notations;
b) if the input is a regular URL, querying the input in a corresponding server through the Internet, and directly obtaining the query result therefrom;
c) if the input includes the native language pronunciation notations, parsing the input against at least one phonetic spelling word list to find out corresponding Internet keyword, and then fetching a corresponding query result; and
d) if the input includes characters of a native language, processing the input as a natural language input in a natual language table, and obtaining a desired Internet keyword, and fetching a corresponding query result of website URL.

2. The method of claim 1, further comprising determination of whether the pronunciation notations are either full phonetic spelling words or abbreviations of first letters of phonetic spelling words, and if the input is a string of full phonetic spelling words, the input string is parsed in a full Chinese phonetic spelling word list with all possible combinations of meaningful words.

3. The method of claim 1, wherein after the entry of the query string in full phonetic spelling, the system parses the query string against a Full Chinese Pinyin Words List (FCPWL) and splits the query string into one or more Chinese phonetic spelling words, that is W={W₁, W₂, . . . W_{N}}; and for each word Wx in W, the system will parse query input in the FCPWL to find the attached Internet Keyword Entry Point List IKEPLₓ, such that each node in IKEPLₓ will point to an Internet Keyword whose phonetic spelling containing Wₓ; and then the system combines IKEPL₁, IKEPL₂, . . . , IKEPL_{N} to obtain a result R=IKEPL₁∪IKEPL₂∪ . . . IKEPL_{N}; each Internet keyword in R having a phonetic spelling word containing at least one word Wₓ in W.

4. The method of claim 3, wherein after combination of the attached Internet keywords, the system further calculates the weight of each Internet keywords in R according to the specified rules, including weighing the count of the number of words within W that the Internet keyword contains, and weighing the total length of words within W that the Internet keyword contains; and then sorting the result list R according to weight of Internet keywords, so that the most approximate result appears at the head of the list, followed by limited number of results in R to obtain a final result Internet keywords list R.

5. The method of claim 1, further comprising determination of whether the pronunciation notations are either full phonetic spelling words or abbreviations of first letters of phonetic spelling words, and if the input is a string of abbreviations of first letters of phonetic spelling words, the input string is parsed in an abbreviation Chinese phonetic spelling word list with all possible combinations of meaningful words.

6. The method of claim 5, wherein after the determination of, the query input being in an abbreviated Chinese phonetic spelling words, the system parses the query input against ACPWL, and splits the query input into one or more abbreviated Chinese phonetic spelling words, that is, W={W₁, W₂, . . . , W_{N}}; and for each word Wx in W, the system parses the word in an abbreviated Chinese phonetic spelling word list (ACPWL) to find the attached Internet Keyword Entry Point List IKEPLₓ, such that each node in IKEPLₓ will point to a Internet Keyword whose abbreviated phonetic spelling words containing the word Wₓ; and then the system combines IKEPL₁, IKEPL₂, . . . , IKEPL_{N} to get a result R=IKEPL₁∪IKEPL₂ . . . IKEPL_{N}; and then each Internet keyword in R has an abbreviated phonetic spelling word containing at least one word Wₓ in W.

7. The method of claim 6, wherein after combination of the attached Internet keywords, the system further calculates the weight of each Internet keyword in R according to the specified rules, including weighing the count of the number of words within W that the Internet keyword contains, and weighing the total length of words within W that the Internet keyword contains; and then sorting the result list R according to weight of Internet keywords, so that the most approximate result appears at the head of the list, followed by limited number of results in R to obtain a final result Internet keywords list R.

8. The method of claim 1, wherein said natual language table is a Chinese English Word List such that the input is parsed therein with all possible combinations of meaningful words to find out attached Internet keyword.

9. The method of claim 8, wherein after parsing the query input against the Chinese English Words List (CEWL), splitting the query input into one or more Chinese words W={W₁, W₂, . . . , W_{N}}; for each word Wx in W, parsing the word Wₓ in the CEWL to find the attached Internet Keyword Entry Point List IKEPLₓ, and then having each node in the IKEPLₓ point toward an Internet Keyword containing the word Wₓ.

10. The method of claim 9, wherein the system combines all IKEPL₁, IKEPL₂ . . . IKEPL_{N} and gets a result R, that is, R=IKEPL₁∪IKEPL₂∪ . . . IKEPL_{N}; and thus having each IKEPLX point to an Internet keyword containing at least one word Wₓ; combining the obtained results, and calculating the weight of each Internet keyword in R according to specified rules, including:
(1) Weighing the count of the number of words within W that the Internet keyword contains;
(2) Weighing the total length of words within W that the Internet keyword contains.

11. The method of claim 10, wherein the system will calculate the comprehensive weight of each Internet keyword based on the above rules, and after the calculation, the system will sort the result list R according to weight of the Internet keywords such that the most approximate result appears at the head of the result list, and the system will limit the number of results in R to obtain the final Internet keyword list.

12. A method of intelligent information processing for homonym words of phonetic spelling comprising the steps of, after the entry of a query string of phonetic spelling words, analyzing all possible homonym words and identifying all of these words as searchable words of full Chinese phonetic spelling; for each of the homonym words of Chinese phonetic spelling, carrying out the calculation of full Chinese phonetic spelling words search in a full Chinese phonetic spelling words list; combining all search results therefrom, analyzing the results and obtaining the final and most possible results.

13. The method of claim 12, wherein said calculation of full Chinese phonetic spelling is carried out by parsing the query string against a Full Chinese Pinyin Words List (FCPWL) and splitting the query string into one or more Chinese phonetic spelling words, that is W={W₁, W₂, . . . W_{N}}; and for each word Wx in W, the system will parse query input in the FCPWL to find the attached Internet Keyword Entry Point List IKEPLₓ, such that each node in IKEPLₓ will point to an Internet Keyword whose phonetic spelling containing Wₓ; and then the system combines IKEPL₁, IKEPL₂, . . . , IKEPL_{N} to obtain a result R=IKEPL₁∪IKEPL₂∪ . . . IKEPL_{N}; each Internet keyword in R having a phonetic spelling word containing at least one word Wₓ in W.

14. The method of claim 13, wherein after combination of the attached Internet keywords, the system further calculates the weight of each Internet keywords in R according to the specified rules, including weighing the count of the number of words within W that the Internet keyword contains, and weighing the total length of words within W that the Internet keyword contains; and then sorting the result list R according to weight of Internet keywords, so that the most approximate result appears at the head of the list, followed by limited number of results in R to obtain a final result Internet keywords list R.

15. A method of intelligent information processing for full phonetic spelling words with southern accent misspellings comprising the steps of, after the entry of a query string of phonetic spelling words, analyzing the entered words against a table listing all possible misspelled consonants and vows for corresponding Chinese characters by southerners; enumerating the misspelling words on the list; separating the query string into several words of phonetic spelling to cover all possible spelling words; carrying out the calculation of full phonetic spelling words search to obtain all possible Internet words of possible search results; analyzing the search results to obtain the final and most possible results.

16. The method of claim 15, wherein after the determination of the query in correct full phonetic spelling words, the system parses the query string against a Full Chinese Pinyin Words List (FCPWL) and splits the query string into one or more Chinese phonetic spelling words, that is W={W₁, W₂, . . . W_{N}}; and for each word Wx in W, the system will parse query input in the FCPWL to find the attached Internet Keyword Entry Point List IKEPLₓ, such that each node in IKEPLₓ will point to an Internet Keyword whose phonetic spelling containing Wₓ; and then the system combines IKEPL₁, IKEPL₂, . . . , IKEPL_{N} to obtain a result R=IKEPL₁∪IKEPL₂∪ . . . IKEPL_{N}; each Internet keyword in R having a phonetic spelling word containing at least one word Wₓ in W.

17. The method of claim 16, wherein after combination of the attached Internet keywords, the system further calculates the weight of each Internet keywords in R according to the specified rules, including weighing the count of the number of words within W that the Internet keyword contains, and weighing the total length of words within W that the Internet keyword contains; and then sorting the result list R according to weight of Internet keywords, so that the most approximate result appears at the head of the list, followed by limited number of results in R to obtain a final result Internet keywords list R.

18. A system of intelligent information processing in the Internet comprising:
means for inputting a query string of words;
means for identifying whether an input of words is one of a URL address, English words, native language characters, and native language pronunciation notations;
means for querying the input in a corresponding server through the Internet, and directly obtaining the query result therefrom if the input is a regular URL;
means for parsing the input against at least one phonetic spelling word list to find out corresponding Internet keyword, and then fetching a corresponding query result if the input includes the native language pronunciation notations; and
means for processing the input as a natural language input in a natual language table, and obtaining a desired Internet keyword, and fetching a corresponding query result of website URL if the input includes characters of a native language.

19. The system of claim 18, further comprising means for checking whether the Chinese phonetic spelling words of the query input contain frequent misspellings due to the southern accent, and means for correcting the misspelled words automatically, and wherein after the determination of the query as correct phonetic spellings and correction of any misspelled words, means for querying the database carries out the search of related URLs.
